(19) United States
(12) Patent Application Publication
(10) Pub. No.: US 2004/0078299 A1
(43) Pub. Date: Apr. 22, 2004

(54) Portable color and style analysis, match and management system

(76) Inventors: Kathleen Down-Logan, Los Altos, CA (US); Mark Smith Logan, Los Altos, CA (US)

Correspondence Address: KATHLEEN DOWN-LOGAN, DIGITAL STYLE SYSTEMS CORPORATION, 171 MAIN ST. # 225, LOS ALTOS, CA, 94022, US

(21) Appl. No.: 10/354,862

(22) Filed: Jan. 30, 2003

Related U.S. Application Data
(60) Provisional application No. 60/352,526, filed on Jan. 31, 2002.
(60) Provisional application No. 60/352,543, filed on Jan. 31, 2002.

(51) Int. Cl. G06F 17/60

(52) U.S. Cl. 705/27

(57) ABSTRACT

This invention relates to the measurement of color and patterns in everyday objects using a simple, inexpensive, self-contained, handheld device (such as a Personal Digital Assistant (PDA) with a digital imaging array video camera attachment). A key component of the invention is a novel color search engine for measurement and matching of color, which runs on the PDA, but can also be used as a server based application, or in a client server model over the internet. The invention will help professionals and consumers to identify, match and remember patterns and manage custom palettes for a wide variety of products anywhere None of the traditional methods for pattern matching adequately address the need for a portable, inexpensive method of acquiring and managing pattern information for a random physical object. Each of them is targeted at a specific industry application, from the industry's point of view.

### CROSS-REFERENCE TO RELATED APPLICATIONS

This application is entitled to the benefit of Provisional Patent Applications Ser. # 60/352,526, filed Jan. 31, 2002, and Ser. # 60/352,543, filed Jan. 31, 2002.

### STATEMENT REGARDING FEDERALLY SPONSORED RESEARCH OR DEVELOPMENT

No work done on this invention was sponsored by and federal grant, contract or other government funding.

### REFERENCE TO COMPUTER PROGRAM LISTING COMPACT DISK APPENDIX

This application includes as an appendix a compact disk with program listings. The program listing on the compact disk are organized into three folders as follows:

1) a fully implemented version of the preferred embodiment of the invention that runs on a Handspring Visor Personal Digital Assistant with an Eyemodule 2 color digital camera, the necessary databases and other supporting files to run these program

2) a version of the fully implemented preferred embodiment that runs on a smart cell phone (with a Palm OS operating system) rather than a Personal Digital Assistant, the necessary databases and other supporting files to run these programs,

3) a version of the color search engine code that can run on any computer server running Microsoft Windows 2000, either dedicated or accessed via the World Wide Web, the necessary databases and other supporting files to run these programs.

### BACKGROUND

1. Field of Invention

This invention relates to the measurement of color and patterns in everyday objects using a simple, inexpensive, self-contained, handheld device (such as a Personal Digital Assistant (PDA) with the capability of digital image capture (such as a CMOS imaging array video camera attachment). Once the colors (or patterns) have been measured, the color and pattern information can be retained and compared to the characteristics of other physical objects, or to similar information in a database. The information can also be transferred to other computer databases for other applications.

2. Description of Prior Art

The primary expected uses for this method is to provide a platform for businesses to collect, analyze, and exchange customer color and style preferences information to enable them to better provide customized products and services. The types of business that would use the invention are those that manufactures or sell carpets, paints, furniture, apparel, or other durable goods. Professionals (such as architects, interior designers, or buyers) and Consumers will also be able to use the invention to acquire, remember, and exchange their own color and style information. Color is the primary unification point across many industries and one of the leading causes of product returns and customer dissatisfaction; style is next. The invention will help professionals and consumers to identify, match and remember colors and patterns (or styles); and manage custom palettes for a wide variety of products anywhere.

None of the traditional methods (swatch books, color samples, etc.) adequately address the need for a portable, inexpensive method of acquiring and managing color or pattern/style information for a random physical object (see Table I for details). Each of them is targeted at a specific industry application, from the industry's point of view. A review of more recent patents indicate that there are inventions that are aimed at parts, or most, of the need addressed by this invention, but each falls short in one or more areas.

An important component of the invention relates to the measurement of color in everyday objects through the analysis of digital color image files (TIF, JPEG, BMP, etc) and the creation of customized color reference databases for comparison to the data extracted from the image files help professionals and consumers to identify, match and remember colors and manage custom palettes for a wide variety of products anywhere. There are no comparable systems available today for extracting color information from digital images. While there are many commercial color databases available, without the link to the consumer's information, the kind of analysis described in the invention cannot be performed today. Also, all of the existing inventions (colorimeters, spectrophotometers) are completely focused on obtaining an image with a digital camera and analyzing it as part of a process. While this invention can be used that way, the primary goal is to analyze digital images obtained from a variety of sources. There is also a significant amount of “art” in the proper construction of the color databases that are used for matching; depending on the application. The color search engine technology can be used on a set of images initially to create a color database reflective of the colors found there, for matching to other images.

This invention finally utilizes the fact that companies work very hard to control the colors of certain commercial and consumer products and product packaging. These colors are extremely uniform over an individual item and also over a collection of items of the same brand or model. The numerical information corresponding to these colors can be acquired. A color imaging and matching system, such as the one described in the applications referenced above, can utilize this to improve the accuracy of imputed color images. By using one of these known commercial product or packaging colors while scanning a target object and its color, the reference information can be used by the Color Search Engine algorithms to increase the accuracy of the imaged colors. There are no inventions that make use of this feature of modern product design and packaging as an aid to color identification.

In U.S. Pat. No. 5,751,829 (1998) and U.S. Pat. No. 6,122,391 (2000), to Ringland, et al. describe a similar system for selecting decorative materials based on large numbers of high-resolution, full color images stored in a compressed format on an inexpensive medium such as a CD-ROM. It provides the closest match to the invention claimed herein in scope and execution. Color data information is added by spectrophotometrically analyzing the decorative material. Color values for a background color and up to four foreground colors are determined. Individual colors are then referenced to a comprehensive color standard system containing a large number of standardized color swatches. Spectrophotometric color referencing allows the data records to be rapidly searched on the basis of color, as well as the other information in the record. Wallpaper patterns, drapery material, floor covering, or paint can then be rapidly selected on the basis of matching color. Various patterns and paints can be compared side by side on a high-resolution computer monitor that has been calibrated to produce an accurate color image. Finally, the chosen paints and other decorating materials can be rendered onto a room image so that the consumer can view an accurate simulation of the chosen materials.

These patents describe a system is generally similar to a portion of the overall scope of this inventions, and includes some similar claims to those shown in the claims section of this document below. One important difference is the use of a calibrated color scanner for input, rather than a CMOS imaging array based digital camera as in this inventions. The use of a scanner limits the utility to 2-dimensional (flat) objects. This invention applies to physical objects of any shape. A second key difference is the use of large data files for each scanner or comparison image, leading to a requirement for data compression and for large amounts of data storage, or data storage media (e.g. CD ROM), to represent the image and color information. In this invention the color information is saved as a simple numerical data set. The third key difference is that the Ringland et. al. al. invention requires the use of spectrophotometer to sample accurate color information for each object that is scanned or referenced. In this invention, the characteristics of the image device itself is calibrated to eliminate the need for this operation.

U.S. Patent Application No. 20010053249 from Krishnamachari, (2001) describes a method for color unitization and similarity measure for content based image retrieval. The invention determines the degree of similarity between a target image and each of a plurality of reference images. The measure used for the degree of similarity between images is based on the human perceptive system, so that images that appear to a human to be similar in color have a higher similarity measure than images that appear to a human to be dissimilar in color. The similarity measure is based on the number of occurrences of each of these associated colors in the corresponding partitions, as well as the color difference between these associated colors. In a preferred embodiment, color difference is determined based upon the CIE luminance-chrominance color space. This invention relates to image retrieval from large image databases, such as photographic archives, digital libraries, catalogs, and videos. The major thrust of the invention is to package the color and image data so efficient comparisons can be made in general this is very similar to the current invention, but the algorithm and other mechanics are very different, as is the scope and end use.

U.S. Pat. No. 6,151,424 to Hsu (2000) describes a system for identifying objects and features in an image using fundamental concept of color perception and multi-level resolution to perform scene segmentation and object/feature extraction in the context of self-determining and self-calibration modes. A flexible and arbitrary scheme is incorporated, rather than a fixed scheme of segmentation analysis. The process allows users to perform digital analysis using any appropriate means for object extraction after an image is segmented. Each transformed image is then projected into a color domain or a multi-level resolution setting. A segmented image is then created from all of the transformed images. The segmented image is analyzed to identify objects. Object identification is achieved by matching a segmented region against an image library of full shape, partial shape and real world. Also provided is a mathematical model called a Parzen window-based statistical/neural network classifier, which forms an integral part of this featureless dual library object identification system. All images are considered three-dimensional. The Hsu patent is a very general one that makes use of similar ideas to the present invention. The detailed algorithms are very different, as is the application for the invention.

U.S. Pat. No. 5,526,285 to Campo, et al. (1995) describes a similar system very specifically used for measuring the colors of processed plastic strands. It uses an analog camera to obtain an image, and then electronically processes the analog data to get a digital image file. The analysis method is different from this invention; the image is acquired in an analog fashion and is not in any standard format after digitization. While color reference information is used to compare to the image, it is very limited information, and there is no notion of extracting generic color information from the image.

U.S. Pat. No. 5,751,450 to Robinson (1998) and U.S. Pat. No. 6,226,399 to Robinson (2001) describe an improved machine vision system that takes color digital images with a sensor, and then analyzes the images to extract color. The first set of image data is transformed within the machine vision system to a second set of image data in an optimal color space having an optimal set of color axes which define an optimal direction wherein the amount of inter axis correlation of the second set of image data is minimized. U.S. Pat. No. 5,751,450 is very different in all but the basic idea obtaining images and measuring and manipulating the color data. However, U.S. Pat. No. 6,226,399 is more relevant in that, similar to the current invention, it processes the images on a pixel-by-pixel basis, and computes a color distance to match to a template. However, the basic aim of the Robinson inventions is completely different seeking to match an observed set of features against a template of the same image for purposes of automated inspection.

There are a number of patents that include the concept of color or pattern/style sensing and match but with the end result to produce a specific physical product: a can of paint, a plastic sheet, or a cosmetic product. While these are generally similar in part to the invention described herein, they are fundamentally different in their specifics and application.

U.S. Pat. No. 6,0142,21 to Plude, Jr. (2000) describes a process for choosing a color most closely replicating an object's actual color. The process includes sensing an object's color and producing a set of digital color data representing the sensed color. It uses a computer processor programmed with a database of sets of digital color data. The computer processor then outputs, to a display, a listing of the closest color matches found in the database, to the sensed color. The user then selects the color and formula defined by the digital information stored in the database corresponding to a color producible using thermal transfer foils or vinyl sheet materials, to that most closely matching the sensed color.

While the patent is written very broadly in its description, it is very specific in its application to comparisons to an available database of color transfer film or vinyl substrates. Instead of a digital camera, it requires the traditional colorimeter or spectrophotometer. The language implies any imaging device that produces color data is covered but it says nothing about how that data would be processed, interpreted, calibrated or stored. It uses a separate computer for the processing and does not meet the portable, handheld, inexpensive characteristics. Our invention also goes well beyond this in creating other pattern information from an image.

U.S. Pat. No. 4,813,000 to Wyman, et al. (1989) describes a method and apparatus for matching a selected color with predetermined available paint colors wherein a portable color meter is used to analyze a selected color and store chromaticity data representing the hue, chroma and brightness of the selected color. That stored chromaticity data is coupled to a computer which compares it with stored chromaticity data in the computer representing available color formulas and then selects one of the stored paint formulas most closely matching the chromaticity data representing the selected color.

The Wyman invention uses a colorimeter rather than a digital camera to measure hue, chroma and brightness of colors to match to paint database. That metric is also a different color measurement system than in the invention described in this application. Also, the Wyman invention refers only to a paint color database, as its objective is to facilitate is the whole process of mixing and preparing paints.

U.S. Pat. No. 6,190,170 to Morris, et al. (2001) includes the basic elements of color sensing, correction and data storage. However it is specifically aimed at producing dental products. There are many similar patents for dental matching.

There are a number of patents that include the concept of pattern sensing and match aimed at a very specific situation, like recognizing faces, retinas, fingerprints, etc. While these are generally similar in part to the invention described herein, they are fundamentally different in their specifics and application.

U.S. Pat. No. 6,292,575 to Bortolussi, et al (2001) describes a real-time facial recognition and verification system for acquiring, processing, and comparing an image with a stored image to determine if a match exists. In particular, the system refines the image data associated with an object based on pre-stored color values, such as flesh tone color. The system includes a storage element for storing flesh tone colors of a plurality of people, and a defining stage for localizing a region of interest in the image. A combination stage combines the unrefined region of interest with one or more pre-stored flesh tone colors to refine the region of interest based on color. This flesh tone color matching ensures that at least a portion of the image corresponding to the unrefined region of interest having flesh tone color is incorporated into the refined region of interest. Hence, the system can localize the head, based on the flesh tone color of the skin of the face in a rapid manner. According to one practice, the refined region of interest is smaller than or about equal to the unrefined region of interest. The Bortolussi invention uses the idea of color information in an image being a key analysis tool, but the pattern analysis otherwise is totally different from that used in the present invention and the application is very limited and specific.

U.S. Pat. No. 5,450,504 to Calia (1995) describes a method of finding a most likely match for a target facial image within a data base of stored facial images comprising determining a score for each data base image as a function of closeness of a quantization of selected facial features between each data base image and the target image and ordering the data base for sequential processing according to the potential value score in descending order, sequentially processing each data base image starting from the highest potential value score by an image comparison process to establish a correlation score for each comparison, and applying one or more decision rules to each comparison to reach a decision. This includes the concepts of a close match and ranking of matches, but it is only applicable to facial pattern matching and uses a different type of algorithm to manipulate the data.

U.S. Pat. No. 6,002,787 to Takhar, et al. (1999) describes system for converting an image-enhanced digitized raster fingerprint image to vector lines in order to generate a unique identification value for the fingerprint. The raster image pixels are converted to vector lines along the fingerprint ridges and the vector lines are classified and converted according to type. The line types are then analyzed and a list of identification features corresponding to the vector line types is generated. The identification features between the vector line types are compared and the image is classified according to fingerprint class. A unique identification value is then generated by numerically encoding the classified identification features. While the Takhar invention and other similar inventions capture image data and tries to match it to other data sets in a database, the algorithms are heavily optimized to fingerprint composition, and the application is limited to a single type of pattern.

There are also patents that describe in detail inventions that achieve the same results as portions of the invention described herein, but in different ways. They also in no way provide the same functionality overall as this invention.

U.S. Pat. No. 5,917,541 Nakagome, et al. (1999) describes a color sense measuring device that includes a solid-state camera and a frame memory for storing output. The output information of the solid-state camera read out of the frame memory is fed to a hue/saturation/lightness transform part in a color sense measuring section for transformation into hue image information, saturation image information and lightness image information for use in measuring the color sense of the object to be measured. Based on the image information output from the color sense measuring section, a feature extract/quantification section extracts a feature value for measuring the color sense of the object and a color sense analysis section judges the color sense of the material of the object on the basis of the feature information output from the feature extract/quanfification section, while at the same time the feature information is supplied to an image processing/display part for display. These features are similar to the color measurement and display portions of the invention describer in this application, but use different color measurement metrics and different algorithms for calculating a color value. The physical elements of Nakagome are very similar to several of those in the invention described in this application, but the scope is limited to sensing and storing data.

U.S. Pat. No 5,343,311 (1004) and U.S. Pat. No. 5,517,334 (1996) to Morag, et al. describes a method and apparatus for efficiently handling, modifying, transmitting, and redisplaying and storing color images. An image is provided which has a plurality of pixels each having color parameters (information) in the form of color coordinates which can be considered a color point in a color space. A representative color value is determined for each pixel in the image. An index value is also provided for each pixel in the image, where each index value represents a particular representative color value in the subset of the first plurality of representative color values. The image may then be modified according to the invention by modifying the representative color values in the subset of the first plurality of representative color values. The image, as modified, may be displayed by using the index value for each pixel to retrieve the modified representative color value for that pixel. The apparatus of the invention includes a processor for determining the representative color values for each pixel and a memory for storing the representative color value for each pixel. This Morag invention is similar in part in that it address color space, calculating and storing color information and display but in a different way than the invention described in this application. The invention is also general, with no specific application as included in the invention in this application.

U.S. Pat. No. 5,319,437 to Van Aken, et al. (1994) describes a handheld portable spectrophotometer with keys for input of instructions by a user, an illuminator for illuminating a sample, and a spectral analyzer for separating light reflected from the sample into spectral components to produce a signal corresponding to the level of each spectral component. A processor is provided for executing the user instructions and for analyzing the signal. The results of the signal analysis are presented on a display. The Van Aken invention does provide handheld method of measuring colors as well as other features not claimed herein. However, it uses a different color sensing process, a hardware versus a software analyzer, and does not address any of the other features of the invention described in the this application.

U.S. Pat. No. 5,798,943 (1998) and U.S. Pat. No. 5,680,327 (1999) to Cook et al describe methods and apparatus for accurately matching colors. The color matching system includes a host computer and a color input device in communication with the host computer. Preferably the color input device is capable of obtaining spectral data, such as that obtained using a spectrophotometer. The host computer includes a color library, a color management system, a monitor, and a user interface. While their invention is similar to part of the functionality in this application, the specific methodology and equipment used is very different.

U.S. Pat. No. 5,701,175 to Kostizak, et al. (1997) Describes a spectrophotometer mouse for making color spectrum measurements of desired areas on a surface over which the mouse is movable. The mouse has a position sensing encoder which is coupled to a programmed computer for identifying the position of the mouse on the surface. The computer automatically actuates the spectrophotometer so that the spectrum of the light from the target area is received at the input of the spectrophotometer and is measured. In addition to providing color spectrum measurements of target areas on a surface. This invention uses a spectrophotometer, not a digital camera. Its focus is on digitally tracking where the head is with a computer, measuring the corresponding color data, and storing that in a database.

U.S. Pat. No. 6,058,357 to Granger (2000) describes a desktop color measurement system that includes an instrument capable of making color measurements. The system includes a host computer and a digital color sensor (DCS) in communication with the host computer. The DCS includes optical elements for making spectral measurements, and control electronics for controlling the optical elements. In a specific embodiment, the DCS is dedicated to the mechanics of acquiring the raw data. The host computer, which may be a personal computer, performs all the calculations needed to convert raw measurement values into spectral data and other color representations such as tristimulus values and density. This also allows the system to function as a colorimeter and a densitometer as well as a spectrophotometer. The DCS control circuitry includes non-volatile writable storage for information obtained during a factory calibration procedure, which information allows the user to recalibrate the DCS in the field. The Granger invention only describes a specific alternative method for calibrating a color sensor using a host computer rather than a handheld device.

U.S. Pat. No. 5,543,940 to Sherman (1996) describes a method and apparatus for reconstructing a spectrum realizable in a medium from signals of a color scanner, includes the steps of obtaining an initial spectrum using a linear vector-space representation of the medium spectra, projecting the initial spectrum onto a logarithmic vector-space representation of the medium spectra to obtain an initial set of coordinates in the logarithmic vector-space and modifying the initial coordinates in an iterative convergence loop until a solution criterion is met. The solved coordinates are then transformed into spectrum using the logarithmic vector-space representation and subsequently may be transformed into calorimetric values. The method and apparatus of this invention thus enable conversion of color scanner signals into calorimetric values. This is accomplished without modification of the prevailing scanner elements. The method may be performed in a digital processing system including a memory, a processor such as a CPU, a scanner for receiving the medium and scanning the media to provide the color input, and a printer for reproducing the colorimetric value. Similar overall to the method described herein, but uses a scanner for input, different models for generating the color information, and does not have the overall scope of this invention.

U.S. Pat. No. 4,812,904 to Maring, et al. (1989) describes a process for color analysis and comparison among reference and test samples for use in quality control applications. The invention requires illuminating each sample under predetermined lighting conditions, scanning the sample with a color video camera, digitalizing the video signal output to produce a digitized signal representative of the components of the color values, preferably the red-green-blue and brightness values (“RGBW”), for each pixel representative of the viewed signal, and reporting and storing the digitized data for subsequent analysis, comparison, display and printout. For comparison purposes, the pixel color values for the samples are analyzed and compared statistically to determine if the reference and test sample match. In one test, the mean of the pixel color value for each sample is ascertained and the test sample is analyzed to determine if its mean is within a tolerance limit for the reference sample expressed in terms of standard deviation values. Various statistical tests provide useful information. The Maring invention is similar to the invention claimed herein in that it uses a video camera to get the RGB data and then talks about transforming the data and comparing it to a reference color. It uses electronics to get the RGB values rather than software. It highlights a method of viewing multiple images against the same background for doing things like quality control, which is the main focus of the invention and much different from that of the invention described herein.

Similarly, there are many patents around optical character recognition, employing either man or machine generated characters, and either alone or in combination or embedded in other images. Applications like handwriting analysis also fall into this category.

U.S. Pat. No. 5,859,935 to Johnson, et al. (1999) describes a method for verifying images against original source data stored in a memory. The first source verifying image can be produced by a human making marks by hand in a field of a form, which can then be provided by a scanner or a facsimile transmission through image input circuitry. If a second source verifying image is received that is the same as the first source verifying image, an operation is performed that would not be performed if the images were not the same, such as an operation accessing a related item of data. For example, the first source verifying image can be received with a document image, and data defining the document image and the original source verifying data can be stored so that a source verifying image that is the same as the first source verifying image must be received before an operation can access the document data and provide it to image output circuitry for printing or facsimile transmission. As a result, the marked form is analogous to a key: only someone who possesses the marked form or a high quality copy can obtain access to the document data. If the marked form is lost or destroyed, the document data cannot be accessed. This is a very different, and limited, form of pattern patching.

U.S. Pat. No. 5,809,167 to Al-Hussein Sep. 15, 1998 describes a page segmentation and character recognition system, which uses a personal imaging computer system, which is connectable to and operable with a computerized local or wide area network that identifies characters in a document on which the characters are formed. The system scans the document to obtain a gray-scale image of the document, generates a binary image from the gray-scale image by comparing the gray-scale image with the threshold, segments the binary image to locate individual characters within the binary image and to determine the shape of the individual characters, extracts gray-scale image information from the gray-scale image for each such individual character based on the location and shape of the character in the binary image, recognition-processes the extracted gray scale image information to determine the identity of the character, and stores the identity of the character. Again, this is image pattern recognition, but of a prescribed and limited set and type of characters.

There are a number of patterns that deal with acquiring an image with a device such as a digital camera and digitizing the information with the goal of correcting the image for input flaws or synthesizing other images from the data.

U.S. Patent Application No. 20010036311 from Tomomatsu, (2001) describes an image processing system, which processes an image including a plurality of object images. Object images related to each other are detected, and are then image processed. The invention relates to a technique of detecting related objects from an input image including a plurality of object images and performing image processing in accordance with the detection result. To avoid the above problems, a technique has been proposed to generate a histogram from pixel data of an original image and detect pixel data corresponding to a predetermined frequency of occurrence, whereby an image correction is performed on the basis of the detected pixel data. This is similar to parts of the algorithms used to process images in the present invention, but the overall application is limited very different; as are the specific algorithms used.

There are also patents that describe in detail inventions that use many specific algorithms for pattern recognition and analysis. These generally (with the exception of the Zhu invention below) do not take advantage of the key color information that is produced by the co-pending inventions to improve the process, and in no way provide the same functionality overall as this invention. Some representative examples of this are cited below.

U.S. Pat. No. 6,332,037 to Zhu (2001) describes an invariant, Eigenvalue based, non-degenerate data structure characterization, storage and retrieval indexing method for enabling easy characterization, storage and retrieval of multi-dimensional data structures involving use of a translation, rotation and scaling invariant index which results from concatenating a series of Eigenvalue calculation mediated index elements determined at a plurality of hierarchical data depth levels.

The invention has as its focus the producing of an Index (I) which is Non-Degenerately descriptive of a Multiple Dimensional Data Image (MDDI), which Index (I) is Image Rotation, Translation, Scaling, and Intensity, Color etc. invariant. (It is noted that Intensity and Color of, for instance, a Digital Data Image are typically combined to form a single value at each Pixel (x, y) location which is a function f(x,y), by for instance, a formula that has as input variables “amounts” of Red, Green and Blue content as well as Intensity for each Pixel). This invention describes one more method of imaging processing, the only real similarity is significant use of color information.

U.S. Pat. No. 6,301,388 to Hiramoto (2001) describes an image matching apparatus that realizes a new method for comparing two images, which differ in sizes and orientations. In an image recognition system, for each of two plane images on which two-dimensional orthogonal wavelet decomposition has been performed, a two-dimensional feature information generating unit detects large spatial gradients in the horizontal and vertical directions of the plane image and expresses the spatial gradients as two-dimensional vectors that are present in spatial positions of the plane image. Next, a three-dimensional vector generating unit uses one of the spatial positions and a direction of a two-dimensional vector present in the spatial position respectively as a reference point and a reference direction, to express the other two-dimensional vectors using three-dimensional vectors which are each made up of a magnitude component and two angle components. Lastly, a judging unit compares a group of three-dimensional vectors generated for one plane image with a group of three-dimensional vectors generated for the other plane image, to judge whether the two plane images match. The Hramoto invention describes one more method of imaging processing with an algorithm that is fundamentally different for that of this invention, and does not approach the scope of this invention overall.

U.S. Pat. No. 6,282,318 to Dietrich, et al. (2001) describes method for combining pattern matching and optimization. The method includes the steps of reading the data elements and corresponding attributes for each of the two data files; performing pattern matching on the elements and the corresponding attributes of each of the two files read in this step; performing optimization on the results for finding a best total matching of the elements of the two files; and, outputting a file selected from the group consisting of the matches produced by step 3, and a file containing the elements that are not matched. In particular, we invention efficiently computes a full or partial matching, that is, a one-to-one mapping, between two sets of elements, preferably based on one or more attributes associated with each of the elements. Our method is especially applicable in cases where there is more than one candidate match for some of the elements; in this case, the method can produce a matching, or partial matching, that is unlikely to have incorrect matches. The Dietrich patent is relevant because it includes the idea of a partial, or “best” match which is critical to how the present invention selects existing wallpaper or other commercial goods that match the target image pattern/color. However, the mechanism for computing a match is totally different and the application is different as well.

U.S. Pat. No. 6,272,245 to Lin (2001) and the very similar U.S. Pat. No. 5,748,780 to Stolfo (1998) describes an apparatus and method for pattern recognition which features characterizing at least two significant portions or regions of the printed pattern on a model document are extracted from a scanned-in image of the model document. Statistical characteristics of each significant region are calculated from the extracted features and saved in a memory. In addition, geometrical relationships, e.g. distances and angles, between the regions are also saved in a memory. The geometrical relationships are represented by the coordinates of the regions in a predetermined coordinate system, e.g. the x-y coordinate system corresponding to the scan area on the platen of a scanner. The ability of comparing the digital image against a codebook of stored digital images is provided. These invention relate generally to image processing machines, for example copying machines or scanner/printers, and more particularly to high-end color copiers and scanner/printers with features and capabilities enabling forgery of currency, securities, negotiable instruments, etc. These inventions are further related to apparatus and methods for the prevention of such forgery on copying machines and the like but is also applicable to any image processing device that scans a document and has the capability to compare a scanned image to a stored image, especially for the purposes of authentication of the document or prevention of its replication. The concepts of digital database representation of the objects and comparison to similar objects is relevant, but the algorithms used and the application are very different.

There are also patents that relate to the specific use of pattern recognition of bar codes and other applications where unique patterns are imbedded in images that are then scanned. These are very different in every way from the current invention so no specific patents are referenced.

There are a number of patents that include the concept of using locally available color as a reference but with the end result to produce a specific physical product: a dental appliance, a matching paint color, or a cosmetic product. While these are generally similar in part to the invention described herein, they are fundamentally different in their specifics and application.

U.S. Pat. No. 6,328,567 to Morris, et al. (2001) describes a method, apparatus and system for automated tooth shade analysis and matching. A method embodiment according to the invention includes acquiring at least one image, the image including one or more teeth of a patient and normalization references, normalizing the at least one image in accordance with the normalization references, determining the color of the teeth as composed of colors from one or more selected shade standards, communicating the standardized color information to a dental laboratory, manufacturing a dental prosthesis based on the standardized color information and installing the dental prosthetic. This invention uses the local tooth color as data to create a matching appliance. This is a very limited and specific use of a specific reference material. The reference colors will vary depending on the use, and are not related to a standard database of commercial colors.

U.S. Pat. No. 6,169,536 to Lee, et al (2001) describes a color picture quality compensation circuit and related control method based on the use of skin color in an image as the reference. This invention is similar to U.S. Pat. No. 6,328,567, although with more general applications, in that it uses something already present in the image (a person's skin color) as a reference for other types of products. However, the reference used is only a local “standard” not a true standard color. The end use for the Lee et al. invention is also very different from that in this current claim.

U.S. Pat. No. 5,478,238 to Gourtou, et al. (1995) describes a method and apparatus for determining the color of a foundation makeup comprising a device for measuring the color of the skin on an arm of a person computing and determining the skin color measured and comparing same with a data base containing a palette of reference foundation colors substantially covering a representative sample of a population of given individuals, the data base containing at least the color of the skin for each individual and a reference foundation color associated with one or more of the skin colors in the data base; and determining from the data base the foundation color associated with the skin color to reproduce the skin color in the data base corresponding to the measured skin color of a person. This is similar to U.S. Pat. No. 6,169,536 in that it uses skin color as a local reference. It extends it more generally with the use of standard databases of skin tones and uses this information to match a specific class of consumes products (cosmetics). The skin tones are still only local references, not commercial standards, and the use is limited to cosmetic formulations.

U.S. Pat. No. 6,024,018 to Darel, et al. (2000) describes color control system for maintaining the color of a printed page of a printing press constant using ink keys in a printing press in accordance with a test image and a reference image. The system includes a unit for imaging an area of the printed page in generating the reference and test images. Again, this represents an example, of a slightly different class, of using a locally created, controlled image as a local reference. The end use and technology is very different from this invention.

U.S. Pat. No. 5,543,922 to Runyan, et al. (1996) describes a color measurement system that includes a measurement reference patch on a continuous sample of color printed matter. The patch has a first predefined shape with a color reference area centrally located on the patch and a high contrast feature located proximate to an edge of the patch. A camera scans the sample and generates a location signal upon detection of the high contrast feature, which permits accurate positioning of a measurement sensor. Again, this represents an example of using specific, controlled image as a local reference. The end use and technology is very different from this invention.

U.S. Pat. No. 4,97,522 to David (1990) describes an apparatus for determining the formulation of paint for use in bodywork repair. It senses the color of the existing paint in several undamaged areas of the vehicle and uses that as a reference to create a color mixture for painting the repaired areas. Again, this represents a slightly different class of using an already present image/source as a local reference. In this case, the local reference is compared to industry standard paint databases, but is used in a very limited and specific application.

Finally there are also patents that describe in detail inventions that achieve the same results as portions of the invention described herein, but in different ways. They also in no way provide the same functionality overall as this invention.

U.S. Pat. No. 6,256,062 to Endo (2001) provides a technique of making color correction by means of a simple operation so that the color difference among imaging apparatus is minimized for a particular color specified by a user. In the color correction operation, a marker is displayed on a viewfinder. A user controls a user interface so as to put the marker on a desired color of a color chart thereby selecting a color to be weighted. Data obtained by measuring the color chart via the camera is compared to color reference data obtained by measuring the same color chart under the same conditions via another camera serving as a reference camera. This invention does use a camera, but only uses a fixed reference, in the imaging device, for the single purpose of normalizing the outputs of two different input devices.

U.S. Pat. No. 5,254,978 to Beretta (1993) describes a reference color selection system for creating a palette of calorimetrically measured colors. Palettes of calorimetrically measured colors representing naturally occurring objects and specified using a standard device independent color specification, such as the CIE color specification, are arranged in a database. A simple-to-use color selection user interface permits a user to retrieve, view, and modify each palette. This color information can then be used to create computer-generated images of other objects by using and manipulating the inputted color references for a class of object. This extends the local standard concept of several of the above patents by creating a library of color information. This is still not commercial standard color information. The information in the Beretta invention is used for a much different purpose than this invention. It is used to create and manipulate new images, not to match colors of objects to other objects with similar or complementary colors.

In addition to samples, swatch books and catalogs, instruments such as calorimeters and spectrophotometers have been in use internally in traditional process and manufacturing industries, and have recently penetrated into retail paint stores with paint measuring/formulation systems. Most of the traditional opportunities have been characterized by “manual searches” for products or samples, while the emerging opportunities have been characterized by “electronic communication and collaboration.

None of the traditional methods adequately address the need for a portable, generalized, and inexpensive method of acquiring and managing color and pattern information for a random physical object. Each of them is targeted at a specific industry application, from the industry's point of view. A review of more recent patents indicate that there are inventions that are aimed at parts, or most, of the need addressed by this invention, but each falls short in one or more areas. There are currently no comparable analysis tools for extracting the color and pattern information from digital image files and analyzing that data against customer created reference databases. While there are many commercial color and pattern databases available (such as from the NBS and many vendors), none of them are optimized for this kind of comparison.

The invention is compared with the current color memory/matching alternatives in the following chart As a reference point, since much work is manual comparison in current markets, tests have shown that only 2-5% of all people have very accurate color memory and most people can usually remember 4 colors at the most.

TABLE 1
Comparison of invention to traditional approaches to the problem

| ? = variable | | Human | Named | Sample/ | | Color- | Spectro- |
|---|---|---|---|---|---|---|---|
| quality | Invention | Memory | Color | Swatch hook | Catalog | imeter | photo-meter |
| COLOR: | | | | | | | |
| Accurate Color Measure | ✓ | 2-5% | ? | ✓ | ? | ✓ | ✓ |
| Real Time Color Measure | ✓ | ✓ | ? | ✓ | | ✓ | ✓ |
| Identify and Remember | ✓ | 2-5% | ✓ | ✓ | | ✓ | |
| anywhere | | | | | | | |
| Match Colors anywhere | ✓ | 2-5% | ? | ✓ | ✓ | ✓ | |
| Coordinate Products | ✓ | ✓ | ? | | ✓ | | |
| SOLUTION: | | | | | | | |
| Customer Information Access | ✓ | ✓ | | | | | |
| Product Information Access | ✓ | ✓ | | | ✓ | | |
| Partner/Supplier Information | ✓ | ✓ | | | ✓ | | |
| Access | | | | | | | |
| Inventory/Delivery/Location | ✓ | phone/fax | | | ? | | |
| Information | | | | | | | |
| Application (Sizing) | ✓ | ✓ | | | charts | | |
| Affordable | ✓ | | | ✓ | ✓ | | |
| Tangible Benefits | ✓ | | | ✓ | ✓ | | |
| Ease of Implementation | ✓ | | | ✓ | ✓ | | |
| Highly portable | ✓ | | | ✓ | ✓ | | |

### SUMMARY

This invention relates to the measurement of color and patterns in everyday objects using a simple, inexpensive, self-contained, handheld device (such as a Personal Digital Assistant (PDA) with the capability of digital image capture (such as a CMOS imaging array video camera attachment). Once the colors (or patterns) have been measured, the color and pattern information can be retained and compared to the characteristics of other physical objects, or to similar information in a database. The information can also be transferred to other computer databases for other applications.

The invention provides a simple and inexpensive method to acquire color and pattern information, such as for a consumer product; so as to identify other products that would be complimentary. It would allow consumers to create and maintain their own color and style palette and use it to compare information with other consumers, or to select commercial products that were complimentary. It would also allow business to quickly identify or create products with color and style characteristics tailored to their customer's unique situations. The combination of color and pattern information enables “styles” of products and product families to be managed.

The invention, a method to measure, store, display and manage true color and pattern information, uses simple, inexpensive, self-contained, handheld hardware (such as a Personal Digital Assistant (PDA) with a digital video camera attachment (such as one using a CMOS Imaging Array) with the capability to store and execute a computer program, as well as and store and display color and pattern data. It takes advantage of the capabilities of PDAs, smart cell phones and other similar handheld devices with camera and computing capabilities and a novel software program, to provide a complete solution for color and style management in an inexpensive, handheld device.

The video camera acquires a representation of any object or printed image and converts that information to a matrix of RGB color data. The computer program uses algorithms developed for the specific video camera, and using the totality of the image color information, to calibrate the color information to a true color representation. The displayed color is the true color that people expect to see based on the color of the object itself. The color composition of the object is summarized into its component colors. The component color information can be displayed on the PDA stored, manipulated, compared to other color information, and sent to other computer hardware or specialized equipment. The pattern information in the image is analyzed and combined with the color information.

### OBJECTS AND ADVANTAGES

Accordingly, several objects and advantages of our invention are:

a) to provide a platform for businesses to collect, analyze, and exchange customer color and style preferences information to enable them to better provide customized products and services. The types of business that would use the invention are those that manufactures or sell carpets, paints, furniture, or other durable goods. Consumers will also be able to use the invention to acquire, remember, and exchange their own color and style information. Color is the primary unification point across many industries and one of the leading causes of product returns and customer dissatisfaction; style is next. The invention will help professionals and consumers to identify, match and remember colors and patterns (or styles); and manage custom palettes for a wide variety of products anywhere. Reverse logistics (product returns) in the supply chain cost businesses tens of billions of dollars from their bottom line profit last year and hundreds of billions in revenue. The growth of direct retailing and e-commerce is making the costs grow even faster. Further complicating the situation for many businesses is to the demand by their customers for more personalized or customized products and style choices in their purchases. Businesses that use images to better communicate product information will benefit the most from this invention. Interaction with electronic data and digital images is now in the mainstream of business communications throughout the supply chain. Solutions that enable repeatable communication of expectations and specifications are showing clear benefits of reduced costs, lower return rates and increased customer loyalty; as well as a significantly more positive buying experience for the consumers themselves. This invention will enable professionals and consumers to identify and remember colors and styles anywhere, match colors and styles anywhere and coordinate products with that color(s) and style(s).

b) to provide a portable, inexpensive method of acquiring and managing color or pattern/style information for a random physical object (see Table I for details) which is not supplied by the traditional methods (swatch books, color samples, etc.) Each of them is targeted at a specific industry application, from the industry's point of view. A review of more recent patents indicate that there are inventions that are aimed at parts, or most, of the need addressed by this invention, but each falls short in one or more areas.

c) to provide a way for professionals and consumers to quickly and easily extract color information from a digital image, such as from a digital video camera, or scanner and compare the color, create their own customized color reference databases, and compare the images color information to these and other commercial databases.

d) to provide a way to the measure color in everyday objects through the analysis of digital color image files (TIF, JPEG, BMP, etc) and the creation of customized color reference databases for comparison to the data extracted from the image files. There are no comparable systems available today for extracting color information from digital images. While there are many commercial color databases available, without the link to the consumer's information, the kind of analysis described in the invention cannot be performed today. Also, all of the existing inventions are completely focused on obtaining an image with a digital camera and analyzing it as part of a process. While this invention can be used that way, the primary goal is to analyze digital images obtained from a variety of sources. There is also a significant amount of “art” in the proper construction of the color databases that are used for matching; depending on the application. The color search engine technology can be used on a set of images initially to create a color database reflective of the colors found there, for matching to other images.

e) to provide the ability to use commercial products as references to improve the accuracy of measurement of an objects color information, and takes advantage of the fact that the color(s) of many consumer and commercial products, or of certain commercial product packaging, is tightly controlled. Placing an object whose color is uniform, consistent over a number of samples, and known in advance along side an object that will be measured provides a very accurate reference. Since many of these products, or packaging systems, are normally available in the environments where the Portable Color Match and Management System is expected to be used (homes, retail stores, business settings) this improvement is basically free.

f) Further objects and advantages of our invention will become apparent from a consideration of the drawings and ensuing descriptions.

### DRAWINGS

In the drawings, closely related figures and elements have same number but different alphanumeric suffixes.

FIG. 1 is shows the components of a version of this invention constructed using a Handspring Visor Color PDA with an IDEO CMOS imaging array video camera attachment.

FIGS. 2a-d shows the detail of the optional custom software switched light source.

FIG. 3 shows an embodiment of the invention based on a Handspring TREO 300 cell phone/organizer combination device, with the Sprint PCS Vision Digital Camera.

FIGS. 4a,b shows an embodiment of the invention based on a Mova smart cell phone with a built in digital camera and flash.

FIG. 5 shows an embodiment of the invention running in a client server mode.

FIG. 6 illustrates the method for creating a color and pattern reference database.

FIG. 7 shows a flow diagram of the optical and numerical data through the invention during operation.

FIG. 8 shows views of the PDA screen illustrating typical user interfaces and displays.

FIG. 9 shows the details of the commercial product reference aspect of the invention.

FIG. 10 shows the calibration pattern used.

REFERENCE NUMERALS IN DRAWINGS

| | | | |
|---|---|---|---|
| 11 | Object to be measured | 12 | CMOS imaging array Video Camera |
| 13 | Personal Digital Assistant (PDA) | 14 | PDA touch sensitive Display |
| 15 | PDA control button section | 16 | PDA Stylus |
| 17a, b | Displayed colors/patterns on PDA | 18 | Displayed object image on PDA |
| 19 | PDA Infrared Transmitter/Receiver | 20 | CMOS imaging array on camera |
| 21 | Computer interface connector | 22 | Stored Color Search Engine |
| | | | Computer Program with Pattern Algorithms |
| 23 | Custom software switched light source | 24 | Slide on battery cover |
| 25 | Battery Enclosure | 26a-d | Four Standard AA Batteries |
| 27 | Hole through which the camera lends | 28a-nn | 40 Nichia 50 degree Light Emitting Diodes |
| | protrudes | | |
| 29 | Light source circuit board for mounting | 30 | Infrared sensor on custom light source circuit board |
| | | | diodes |
| 31 | Sprint PCS Vision Plug-in Digital Camera | 32 | Handspring TREO Combination Cellular |
| | | | Phone/Organizer |
| 33 | Connector to attach camera to phone | 34 | Camera Digital Image Sensor |
| 35 | Color display on TREO cellular phone | 36 | Keyboard (“Thumb board”) on TREO cellular |
| | | | phone |
| 37 | Mova cellular phone with built-in digital | 38 | Outside Color Display on Mova cellular phone |
| | camera and flash | | |
| 39 | Digital camera on Mova cellular phone | 40 | Flash lighting device on Mova cellular phone |
| 41 | Red Light Emitting Diode Low Battery | 42 | Standalone Digital Camera |
| | Warning light on customer light source | | |
| 43 | Network Attached Personal Computer | 44 | Displayed captured image |
| | with display, keyboard and pointing device | | |
| | (e.g. a mouse) | | |
| 45 | Images downloaded from Remote Server | 46 | Connector from Digital Camera to |
| | | | Personal Computer |
| 47 | Connection between Personal Computer | 48 | Network, Internet or Modem attached |
| | and Remote Server | | Remote Server with data storage |
| 49 | Inside display on Mova cellular phone | 50 | Keyboard on Mova cellular phone |
| 51-56 | Color/Pattern Reference samples | 57 | Remote Image Server Software and Databases |
| 58 | Computer used to write Color Search | 59 | Computer Interface cable |
| | Engine code and create databases | | |
| 60 | Image data received by imaging array | 61 | Color/Pattern Data outputted by camera |
| 62 | Processed Color/Pattern Data | 63 | Master Pattern Database in PDA |
| 64 | Standard Infrared Light Emitting Diode | 65 | Computer interface connector |
| 66 | Color/Pattern Reference database in PDA | 67 | Displayed color/pattern names and |
| | | | percentages |
| 68 | Displayed commercial patterns | 69 | Displayed commercial matched pattern |
| | | | names and percentages |
| 70 | Displayed commercial matched color | 71-73 | Commercial Color References |
| | names and percentages | | |
| 77 | Displayed color names and percentages | 78 | Commercial Reference Data |
| | | | from Manufacturer |
| 79 | Calibration pattern - color section, with | 80a, b | Calibration pattern —black fiducials |
| | 16 squares, colored as indicated | | |
| 81 | Calibration pattern - Location Instructions/guide | | |

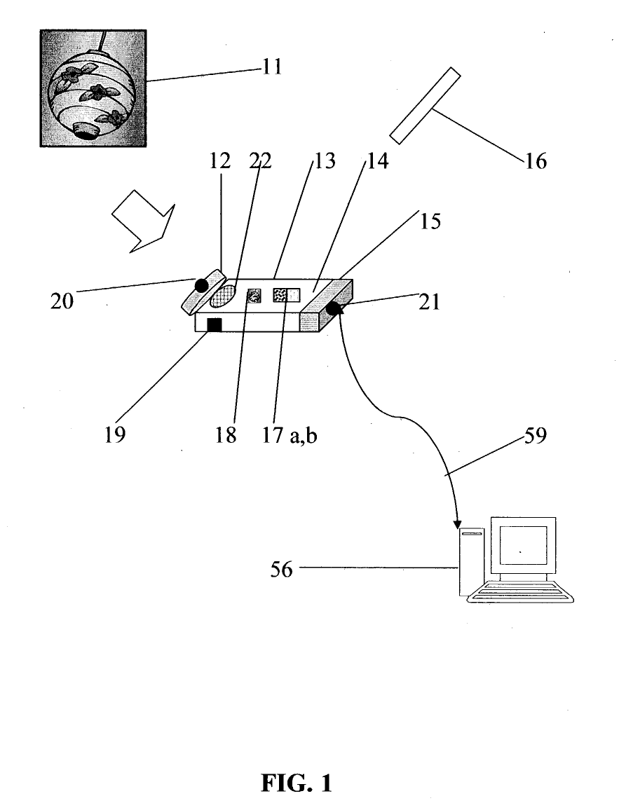

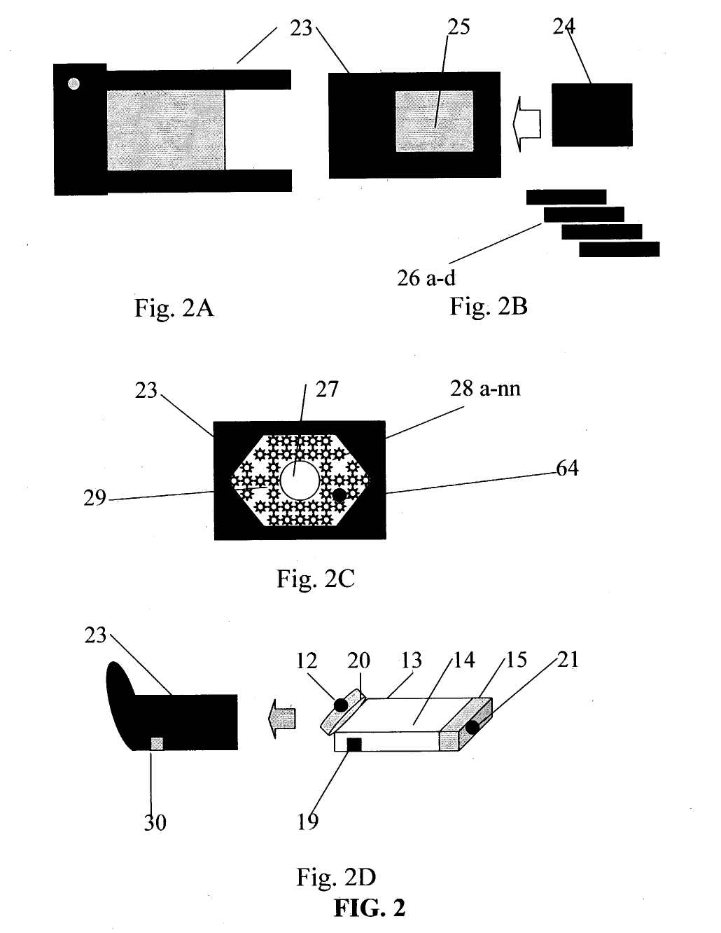

Description—FIGS. 1 and 2—Preferred Embodiment

The preferred embodiment of the invention is a program, and a set of databases, that reside on any PDA (or other device such as a digital camera, cellular phone or portable computer—with the capability to store and execute a computer program, as well as and store and display color data), with an integrated software switched light source (as needed), or flash, to provide uniform lighting if necessary for marginal use environments. This invention is primarily a synthesis of existing commercially available elements combined in a novel way—and the Color Search Engine software, which is new art. The preferred embodiment, uses commercially available hardware in its implementation, except or he light source, which is new art. The other additional and alternative embodiments do not rely on a light source because of improvements, actual and expected, in the imaging devices. It is also likely that the need for calibration will disappear as successive embodiments take advantage of the availability of more advance imaging technology.

There are three methods of calibration of the device available: 1) One time or periodic calibration in the use environment using a large 16 color calibration target, 2) Use of a small 16 color stick on calibration decal in each image area, and 3) identification or commercial color references in the image area whose color data is pre-stored in the device.

The invention can be used in three basic modes of operation. In all three modes of operation the invention can either analyze the entire image, or the user can select portions of the image, down to a single pixel, for analysis. All three modes have been implemented in commercially available products.

In the first mode, the image can be acquired by a device, such as a PDA with a color digital camera attachment, where the program and the created custom color and pattern databases reside. The image is analyzed and the program creates the analysis information. The information is compared to the customer database to provide a specific file of analyzed information about the image in a format unique to the application, and based on the customer database. The camera can either be an integral part of the device, an attachment or a plug in module.

In the second, the digital image, such as a JPEG file, is available in a database somewhere. It is transferred by any file transfer method to the PDA or computer where the program and the created custom color and pattern databases reside. The image is analyzed and the program creates the analysis information. The information is compared to the customer database to provide a specific file of analyzed information about the image in a format unique to the application, and based on the customer database.

In the third mode, a consumer at home can create an image, such as with a digital camera. That image can then be uploaded using the Internet, or other file transfer method, to a product vendor's or service provider's server, where resides the program and the databases. The server can send back to the consumer a screen that allows the consumer to manipulate the image to match the color pattern he wants, to review database information, etc.

A combination of modes one and two is also available, where the imaging takes place on a PDA or cell phone-like device with wireless capability and the data is sent back to a serer for analysis. The results are then displayed on the hand held device. This has the advantages of moving the potentially large data storage requirements to a cheaper alternative medium and potentially reducing the processing time by taking advantage of the faster processors available in remote servers.

Then invention include as a part a specification for a novel custom light sources, which is fully integrated, in the preferred embodiment, with the Personal Digital Assistant hardware and the application program software. It provides uniform light of a controlled brightness for those use environments where additional illumination is determined to be needed to get the desired accuracy in the image.

Another novel aspect of the invention is the ability to use of commercial products as references. This can be used as a method to improve the accuracy of measurement of an objects color information, and takes advantage of the fact that the color(s) of many consumer and commercial products, or of certain commercial product packaging, is tightly controlled. Placing an object whose color is uniform, consistent over a number of samples, and known in advance along side an object that will be measured provides a very accurate reference. Since many of these products, or packaging systems, are normally available in the environments where the Portable Color Match and Management System is expected to be used (homes, retail stores, business settings) this improvement is basically free.

The benefit can be realized in three ways: 1) Pre-programming the system with color information provided by the manufacturers of the products and packaging systems, 2) calibrating the system with several common consumer or commercial references in advance of first use to acquire any object color information and 3) calibrating the system with the reference product or packaging system before making a measurement on the target object.

FIG. 1 shows the preferred embodiment of the present invention. The Handspring Visor Personal Digital Assistant 13 includes a Liquid Crystal Display (LCD) 14 on its top surface as shown. It also includes a section with control buttons 15. The LCD screen is touch-sensitive so information can also be entered there using a pen-shaped stylus 16. The IDEO Eyemodule 2 Color Video camera 20 is attached to the PDA 13. It includes a CMOS imaging array 12 that senses the appearance and color of an external object 11. The PDA includes an infrared transmitter/receiver 19 that can be used to input program information and data, and to send data to other external devices. There is a version of the Color Search Engine software program 22 stored and running on the Palm operating system resident in the PDA. This would be loaded into the PDA via the computer interface connector 21 and interface cable 59 from the Computer 58 on which it was originally written. Note that in the figures, a crosshatched oval on the surface of the PDA 13 is used to show the presence of computer software and databases in the PDA. The clear block-style arrow is used in all the figures to show the movement of data.

FIG. 2 shows the detail of the optional custom software switched light source. For ease of presentation, this optional component of the invention is not shown in all of the figures. FIG. 2a shows a top view of the custom light source, showing the placement of red Light emitting diode that provides a low battery warning 41. FIG. 2b shows a bottom view. Four standard “AA” batteries, 26a-d, are inserted into the battery holder 25, and the battery holder cover 24 slides over the battery holder 25. FIG. 2c shows a front view of the custom light source 23. There is an opening in the center 27 of the front of the light source 23 where the front of Color Video camera 20 will protrude through during operation. Surrounding the hole 27 is an array, 29a-nn, of 40 standard Nichia 50 degree Light Emitting Diodes. These are mounted on a Light source circuit board 29. Also mounted on the circuit board is a standard infrared light emitting diode 64. This diode is used to implement the software switching of the light source by infrared signaling to the PDA 14 Finally, FIG. 2d shows how the PDA 14 slides into the custom light source 23 aligned such that the PDA Infrared Transmitter/Receiver is next to the infrared control hole 30, which is on the inside surface of the custom light source 23 and allow line of sight access to a standard light emitting diode which is mounted on the circuit board 29. Note that the grey shaded block-style arrow is used in all the figures to illustrate the mating of two objects. Line arrows show the physical movement of objects.

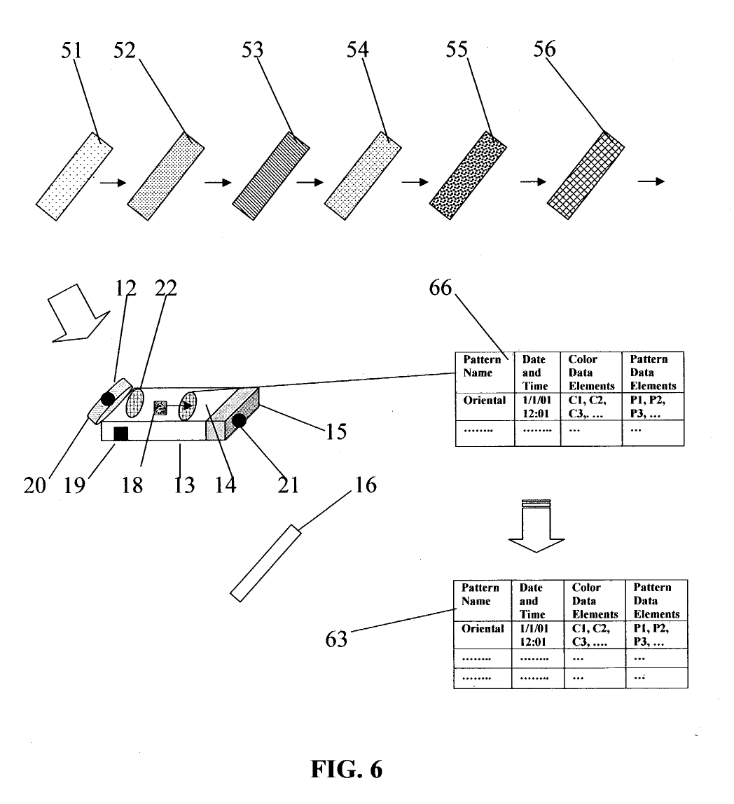

Operation—Preferred Embodiment—FIGS. 6-10

FIG. 6 shows the initial setup and data loading operation for the invention in the preferred embodiment. A series of patterned and/or colored samples (51-56) of painted surfaces, patterned fabric, etc is presented to the camera 12. The operator uses the displayed image 18 on the PDA 13 to monitor the pattern being sensed. The operator initials the sample capture operation via the PDA touch sensitive Display 14. The operator uses the same method to input information about the sample (pattern name, date and time). The color and pattern data and other information is then saved in a Color/Pattern Reference data base 66 which feeds into the Master Color/Pattern Database 63 once the display color and pattern information has been calculated. Alternatively color and pattern data available from manufactures can be downloaded directly into the PDA using the Computer interface connector 21.

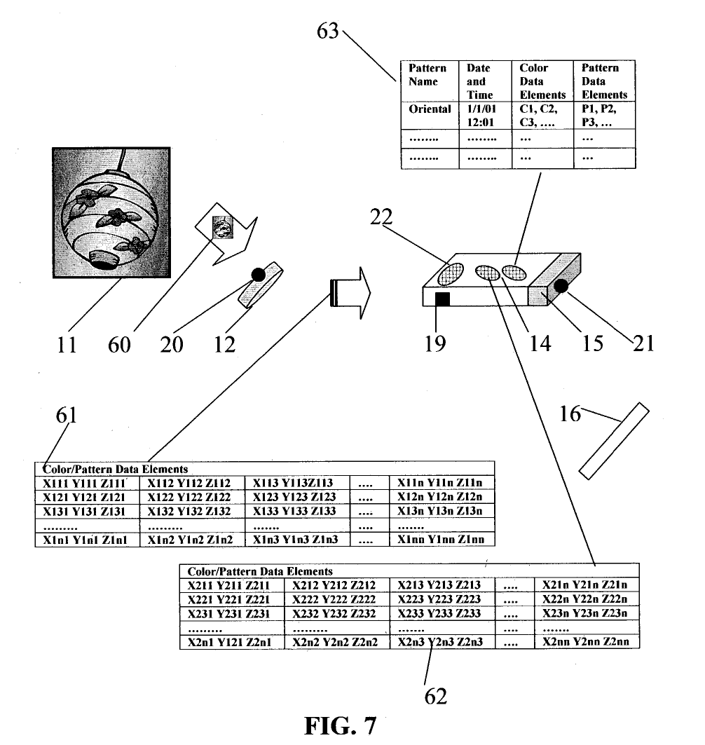

FIG. 7 shows the acquisition and match operation for the invention. An object 1 whose pattern composition is to be measured is presented to the camera 12. The operator uses the displayed image 18 on the PDA 13 to be sure that the correct object or portion of the object is being sensed. Once the operator is satisfied, he/she initials the sample capture operation via the PDA touch sensitive Display 14. The Color Search Engine program with pattern algorithms 22 analyzes the Color/Pattern Data 61 outputted by camera 12. It uses information about the ambient lighting, the characteristics of the camera, the pattern characteristics of the display 14, etc to create a calibrated set of processed color/pattern data 62. Depending on the application, the processed color/pattern data 62 can be manipulated to provide information about the components of the pattern in the object, percent of pattern(s), etc. The data can also stored and compared to information in the Master Pattern database 63 to find matching commercially available patterns, complementary commercial patterns and patterns, etc.

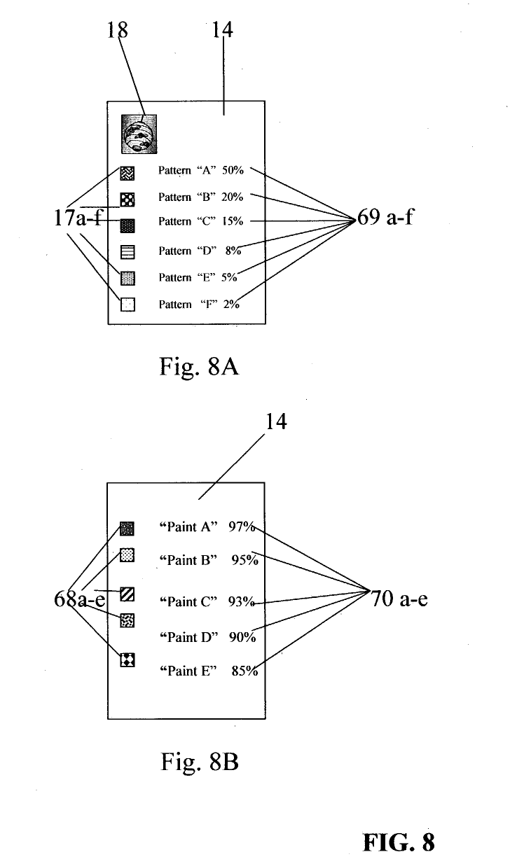

FIG. 8 shows sample images of simple displays the operator would see on the LCD display 14 during operation. In FIG. 8A the sensed object image 18 is shown, along with the displayed component patterns 17a-f on the left side of the image. On the right side is shown the corresponding Pattern names and percentages match to those patterns present in the image/object 69a-f. In FIG. 8B a different display is shown that identifies five commercially available product patterns (e.g. paint) and shows their patterns 68a-e on the left and the corresponding degree (percentage) of their match 70a-e to the pattern in the object. Many other similar information displays can be presented for pattern and palette management. Other types of value added displays, summaries, etc. based on different databases are also included in the invention.

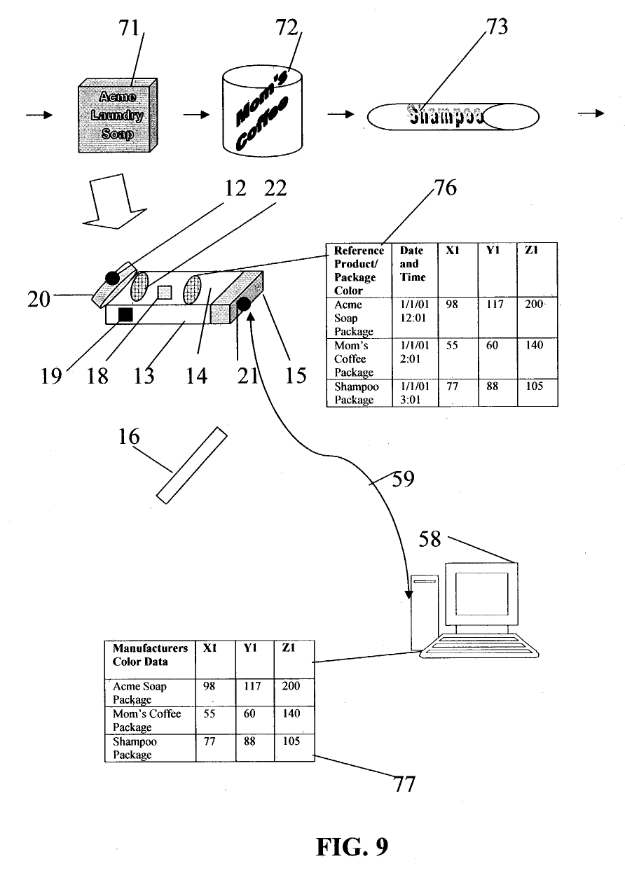

FIG. 9 shows the options for incorporating the commercial reference color data into the Color Search Engine 22. In the first method, illustrated on the right side of the figure, one or more Commercial Color References (71-73) are presented to the IDEO Color Video camera 20, attached to the PDA 13. The operator uses the displayed image 18 on the PDA 13 to monitor the object being sensed. The operator initials the color capture operation via the PDA touch sensitive Display 14. The operator uses the same method to input information about the sample (reference name, date and time). The reference color data is then saved in a Color Reference database 76.

The lower right side of FIG. 9 illustrates the alternative method for inputting commercial reference color data. If the actual Commercial Reference Data 77 itself can be acquired for the desired Commercial Color References 71-73 product or packaging system from their manufactures it can be loaded directly into the PDA 13 through the Computer interface connector 35 using cable 59 and computer 58 and stored in the Commercial Reference Data database 76.

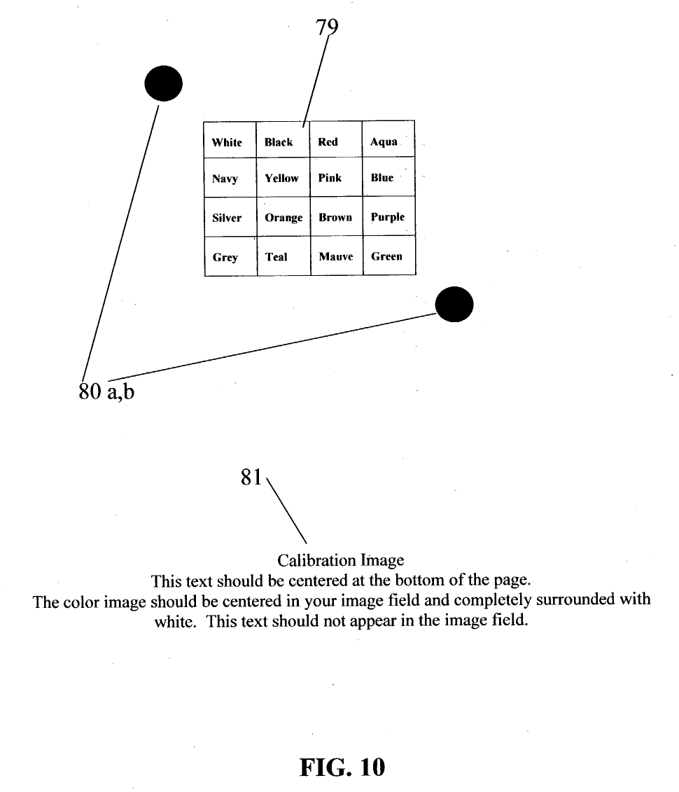

FIG. 10 shows the printed elements that are used to create calibration information in images. The calibration pattern 79 is a matrix of sixteen colored squares, identified and arranged as shown. There are two large black circles 8a,b that are used as fiducials to orient the pattern. There are calibration instructions 81 printed on the bottom of the page, which serves as a reminder of the process and as an orientation guide. The user simple images the combination and the program calculates the calibration for that particular environment.

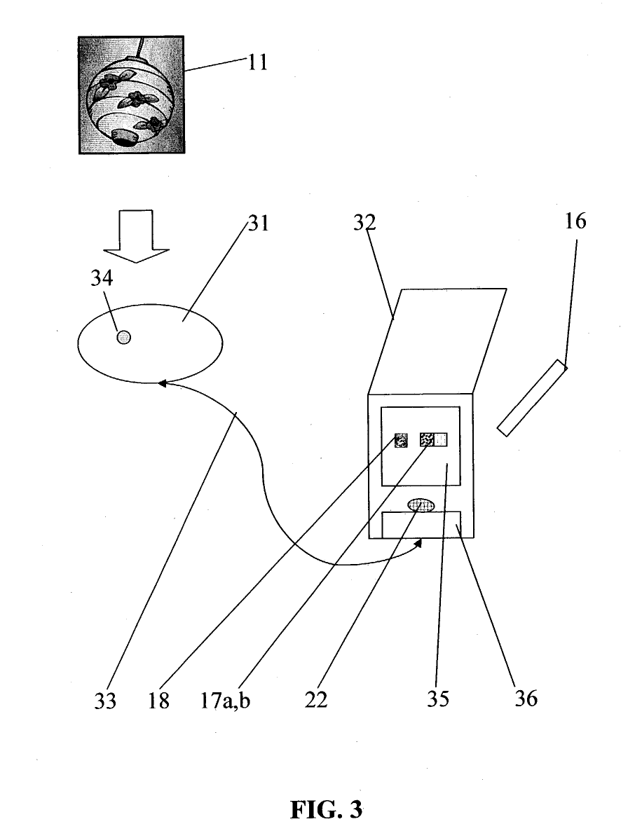

Additional Empodiements—Description And Operation—FIGS. 3, 4 and 5

FIG. 3 shows an embodiment of the invention that uses a commercially available Handspring TREO Model 300 combination cellular phone and Palm OS Organizer 32 used in combination with a commercially available Sprint PCS vision digital camera 31 with its plug-in connector 33. The image of the object 11 is captured by a digital sensor 34 on the camera 31. The data is moved to the cellular phone/organizer through connector 33. Flipping up the cover on the phone/organizer 43 exposes a color display 35 and a small keyboard (“thumb board”) 36. An appropriate version of the Color analyzed software 22 is running on the phone/organizer 32. Program commands can be entered either using the keyboard 36 or the stylus 16. The captured image 18 and the displayed colors/patterns 17a,b are shown on the color display 35.

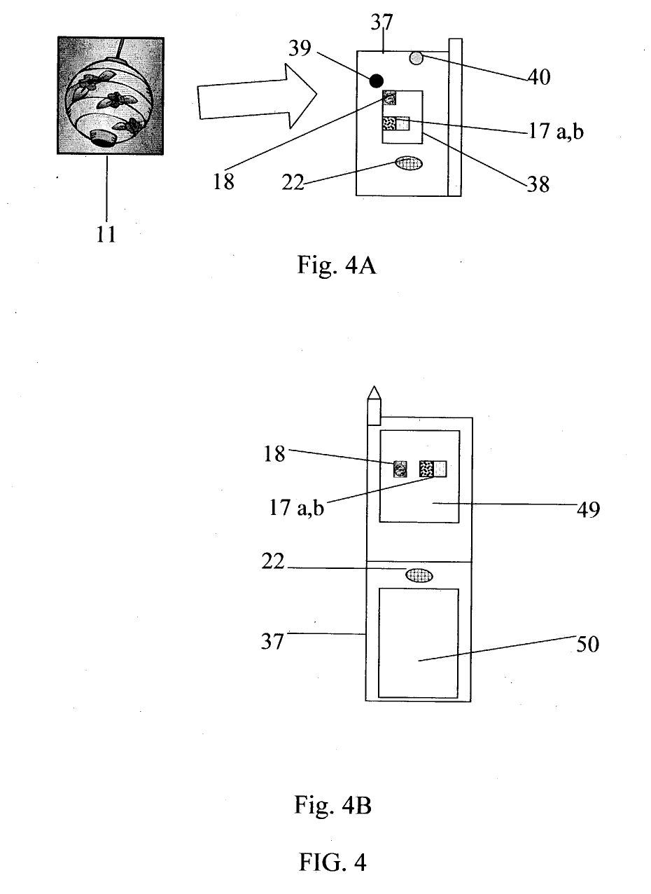

FIG. 4a shows an embodiment of the invention implemented using a commercially available Mova smart cellular phone 37. This has a fully integrated digital camera 39 and a flash lighting device 40, and a color display 38 as parts of the basic phone itself. This design is typical of a number of smart phones now on the market. There is an appropriate version of the Color Search Engine program 22 resident in the memory of the Mova phone 37. The image of the object 11 is captured by a digital camera 39 (with the assistance of the flash lighting device 40 as needed). The captured image 18 and the displayed colors/patterns 17a,b are shown on the outside color display 38. FIG. 4b shows the Mova smart cellular phone 37 in the open position. Program commands are entered either using the keyboard 50. The captured image 18 and the displayed colors/patterns 17a,b are shown on the larger inside color display 49. The Color Search Engine program 22 is still resident in the phone 37.

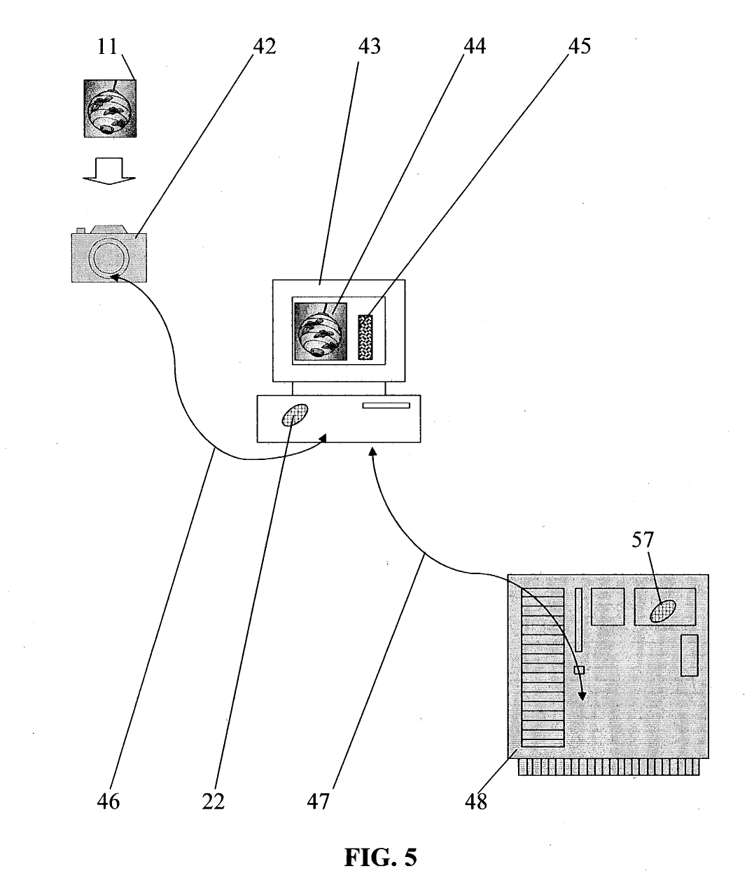

FIG. 5 shows an embodiment of the invention using digital camera 42, a personal computer with display, keyboard and point device (mouse) 43 and a remote server, or host, 48. All of these are standard commercially available products. In this embodiment, a user takes a picture of an abject 11 with their digital camera 42. Then they use connector 46 to send that image to their personal computer 43, where the displayed image 44 can be seen on the computer's display. Using the keyboard or mouse, the user can manipulate the image, selecting certain portions to be matched, and identified, etc. using an appropriate version of the Color Search Engine software 22. Requests and data is sent via connection 47 to the remote server/host 48, where resides Remote Image Server Software and Databases 57 that can work together with the local Color Search Engine software 22 to enable the user to perform the activities the are interested in. The search or match results, further queries, purchase transactions, etc. are sent back and forth on connection 47 until the task is completed.

Alternative Empodiements

While the version of the invention described in FIGS. 1, 2 and 3 have been built and tested, there are several other alternative embodiments that will also be tested. With the appropriate version of the Color Search Engine software, any device that includes a color video camera, a color display, and a processor and memory that can run the Palm or similarly featured operating system can be utilized in a version of the invention. These other devices would include digital cameras, cellular telephones, laptop or palmtop computers, and other similar devices.

What is claimed is:

1) A method for gathering, storing, manipulating displaying pattern information, including color information, about three dimensional objects using a personal digital assistant and digital camera and a stored computer program comprising the steps of:
a) gathering pattern image reference data for commercially available by scanning a variety of materials samples with a color digital camera,
b) creating and storing on the personal digital assistant a searchable database by coordinating the pattern image data for each sample with the pattern descriptive information for the same sample.
c) offering information to the users on matching and complimentary patterns using computer algorithms operating on the database,
d) displaying scanned and database patterns and pattern information on the display screen of the personal digital assistant,
e) determining the pattern composition of any object using the camera and the personal digital assistant and displaying that information,
f) converting the pattern and color data for an object to a true perceptual version using a stored computer program and displaying it on the personal digital assistant,
g) manipulating the pattern information for an object to with a stored computer program compute the percentage of match to different patterns and other useful metrics,
h) transmitting all of the data described above data via the infrared port or computer interface connector of the personal digital assistant to another personal digital assistant, personal computer, printer, display, web page or other electronic device,
i) imputing pattern reference data, where available, directly from a commercial database, using the computer interface connector, and converting it to the appropriate format, and loading it into the database,
j) outputting the pattern and pattern information data to a printer.
whereby an operator can acquire, store, manipulate and compare to a database of commercially available products true color and pattern information using an integrated handheld device and
whereby a consumer can determine the color (s) and pattern(s) of any consumer product, such as a couch or wallpaper, carry this information with them easily, determine other patterns that match or complement and at a later point in time compare the information to help in purchasing other decorating products from suppliers; similarly a vendor of consumer or industrial products could use the invention to communicate clearly the characteristics of their products consumers, determine the appropriate product from a mix, assure that the correct products were delivered, and easily replace damaged products.

2) a method as in claim one, wherein the camera and personal digital assistant are replaced by a digital camera with an operating system, stored Color Search Engine program and pattern algorithm, processor, memory and interface that provides the same functionality.

3) a method as in claim one, wherein the camera and personal digital assistant are replaced by a cellular phone or other wireless communication device with an operating system, stored Color Search Engine program and pattern algorithm, processor, memory and interface that provides the same functionality.

4) a method as in claim one, wherein the camera is replaced or complimented by a compact spectrophotometer that can be attached to the personal digital assistant.

5) a method as in claim one, wherein the personal digital assistant is replaced by a laptop or palmtop computer with an attached digital camera, the computer having an operating system, stored Color Search Engine program, processor, memory and interface that provides the same functionality.

6) a method as in claim one, two, three, four or five where a specific light source, such as a flash attachment, an array of light emitting diodes, or a laser illuminator, is attached to the personal digital assistant.

7) A method as in claim one, two, three, four or five where the imaging is made more accurate by using reference color information is provided by incorporating in the algorithm known color data for manufactures products or packaging by either:
a. imputing consumer and commercial product and packaging system color reference data, where available, directly from a manufacturers database, using the computer interface connector, and converting it to the appropriate format or
b. creating and storing on the personal digital assistant a searchable database by coordinating the pattern image data for each sample with the pattern descriptive information for the same sample and
c. including an example of the commercial product in the field to be imaged.

8) A method as in claim one, two, three, four or five where a specific light source, such as a flash attachment, an array of light emitting diodes, or a laser illuminator, is attached to the personal digital assistant.

9) A method for obtaining, creating and analyzing color information in any format of image data files of two- or three-dimensional objects using a personal digital assistant and digital camera and a stored computer program comprising the steps of:
a) creating a computer image data file (such as a JPEG) for an object any object using the camera and the personal digital assistant and displaying that information,
b) allowing the user to select the whole image or a portion of it for analysis,
c) determining the color composition of the image,
d) manipulating the color information for an object to with a stored computer program compute the percentage of different color and other useful metrics,
e) displaying scanned and database colors and color information on the display screen of the personal digital assistant,
f) transmitting all of the data described above data via the infrared port or computer interface connector of the personal digital assistant to another personal digital assistant, personal computer, printer, display, web page or other electronic device,
g) imputing color reference data, where available, directly from a commercial database, using the computer interface connector, and converting it to the appropriate format, and loading it into the database,
h) offering information to the users on matching and complimentary colors using computer algorithms operating on the database
i) outputting the color and color information data to a printer.
whereby an operator can acquire, store, manipulate and compare color images to a database of commercially available product colors using an integrated handheld device and
whereby a consumer can determine the color(s) of any consumer product or available image, such as a couch or wall paper, carry this information with them easily, determine other colors that match or complement and at a later point in time compare the information to help in purchasing other decorating products from suppliers; similarly a vendor of consumer or industrial products could use the invention to communicate clearly the characteristics of their products consumers, determine the appropriate product from a mix, assure that the correct products were delivered, and easily replace damaged products.

10) A method as in claim eight, wherein the camera and personal digital assistant are replaced by a digital camera with an operating system, stored Color Search Engine program, processor, memory and interface that provides the same functionality.

11) A method as in claim eight, wherein the camera and personal digital assistant are replaced by a cellular phone or other wireless communication device with an operating system, stored Color Search Engine program, processor, memory and interface that provides the same functionality.

12) A method as in claim eight, wherein the camera is replaced by a compact spectrophotometer that can be attached to the personal digital assistant are replaced by a cellular phone or other wireless communication device with an operating system, stored Color Search Engine program, processor, memory and interface that provides the same functionality.

13) A method as in claim eight, wherein the personal digital assistant is replaced by a laptop or palmtop computer with an attached digital camera, the computer having an operating system, stored Color Search Engine program, processor, memory and interface that provides the same functionality.

14) A method as in claim eight, wherein the computer software runs on a remote computer or server, and the images are presented to the user in an Internet browser interface. In this method, the image to be analyzed can be uploaded by the user form a digital camera, computer, or other input device to the remote server for analysis; or selected from databases on the remote server.

15) A method as in claim eight, nine, ten, eleven, twelve or thirteen where the image files are imputed or downloaded from another computer or other external source.

16) A method as in claim eight, nine, ten, eleven, twelve or thirteen where a specific light source, such as a flash attachment, array of light emitting diodes, or a laser illuminator, is attached to the personal digital assistant or other embodiment.
